(19) United States
(12) Patent Application Publication
(10) Pub. No.: US 2007/0295810 A1
(43) Pub. Date: Dec. 27, 2007

(54) Tamper-proof card reader

(76) Inventors: Juergen Hopt, Rottweil (DE); Michael Storz, Bad Duerrheim (DE)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/821,019

(22) Filed: Jun. 21, 2007

(30) Foreign Application Priority Data
Jun. 23, 2006 (EP) 06 012 915.2-1238

(51) Int. Cl. G06K 7/06

(52) U.S. Cl. 235/441

(57) ABSTRACT

In accordance with the invention, in a card reader (1) comprising a contacting unit (2) for a card (3) that has been inserted through a card insertion opening (5), the contacting unit (2) is disposed in a pocket (6) which is open at the card insertion opening (5) and has a fine-meshed conductor path structure with at least one continuous conductor path (9), and is formed from at least one conductor path foil (7) by mutually overlapping sections, wherein the overlapping sections comprise conductor path ends which are interconnected in an electrically conducting fashion to form the continuous conductor path (9), and wherein one pocket side that forms the bottom (8) of the card reader (1) has a recess (10) for contacting the contacting unit (2).

This application claims Paris Convention priority of EP 06012915.2 filed 23 Jun. 2006, the complete disclosure of which is hereby incorporated by reference.

The present invention relates to a card reader, in particular a chip card reader, comprising a contacting unit for a card that has been inserted through a card insertion opening.

### BACKGROUND OF THE INVENTION

With conventional card readers of this type, it is possible to manipulate the data exchange with a card by contacting the electrical contacts of the contacting unit.

It is the object of the present invention to protect a card reader of the above-mentioned type against such manipulation, i.e. to provide a “safe card reader”.

### SUMMARY OF THE INVENTION

This object is achieved in accordance with the invention in that the contacting unit is disposed in a pocket which is open at the card insertion opening, has a fine-meshed conductor path structure with at least one continuous conductor path, and is formed from at least one conductor path foil by mutually overlapping sections, wherein the mutually overlapping sections comprise conductor path ends which are interconnected in an electrically conducting fashion to form the continuous conductor path, and wherein a pocket side that forms the bottom of the card reader has a recess for contacting the contacting unit.

The connecting contacts of the card reader are connected to a corresponding plug of a customer's printed circuit board and then mounted to the customer's printed circuit board, at the same time establishing an electric connection between each continuous conductor path of the pocket and the customer's printed circuit board. The connecting contacts of the card reader are located within the bottom recess of the pocket, which is covered by the customer's printed circuit board, and are therefore not accessible from the outside. When the pocket is removed or destroyed e.g. by drilling, one or both continuous conductor paths, through which a current flows during operation, are cut through. A control unit of the customer's printed circuit board will detect this and subsequently prevent any reading process or render the contacting unit inoperative. Unnoticed manipulation of the contacting unit is therefore no longer possible, and a “tamper-proof” card reader is obtained.

The invention also relates to a one-piece conductor path foil blank for the pocket of the above-described card reader, wherein the blank has a cover section that forms the upper side of the pocket, at least one bottom section that forms the bottom of the pocket and comprises a recess, and side wall sections, wherein at least the cover section and the side wall sections have a fine-meshed conductor path structure with several open conductor paths which terminate in exposed contact surfaces of the sections, which abut each other in pairs in the erected state of the pocket, and in exposed contact surfaces of the bottom section.

Further advantages of the invention can be extracted from the description, the claims, and the drawing. The features mentioned above and below may be used individually or collectively in arbitrary combination. The shown and described embodiment is not to be understood as an exhaustive enumeration but has exemplary character for describing the invention.

### BRIEF DESCRIPTION OF THE DRAWING

FIG. 1 shows a perspective view from below of the inventive card reader with a contacting unit which is disposed in a pocket;

FIG. 2 shows a top view of the bottom of the card reader of FIG. 1;

FIGS. 3a, 3b show the outer and inner sides of a conductor path foil blank from which the pocket of FIG. 1 is folded.

### DESCRIPTION OF THE PREFERRED EMBODIMENT

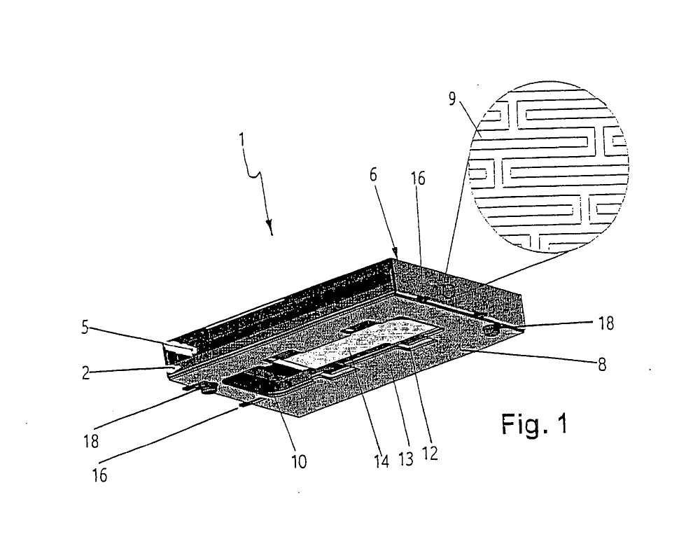

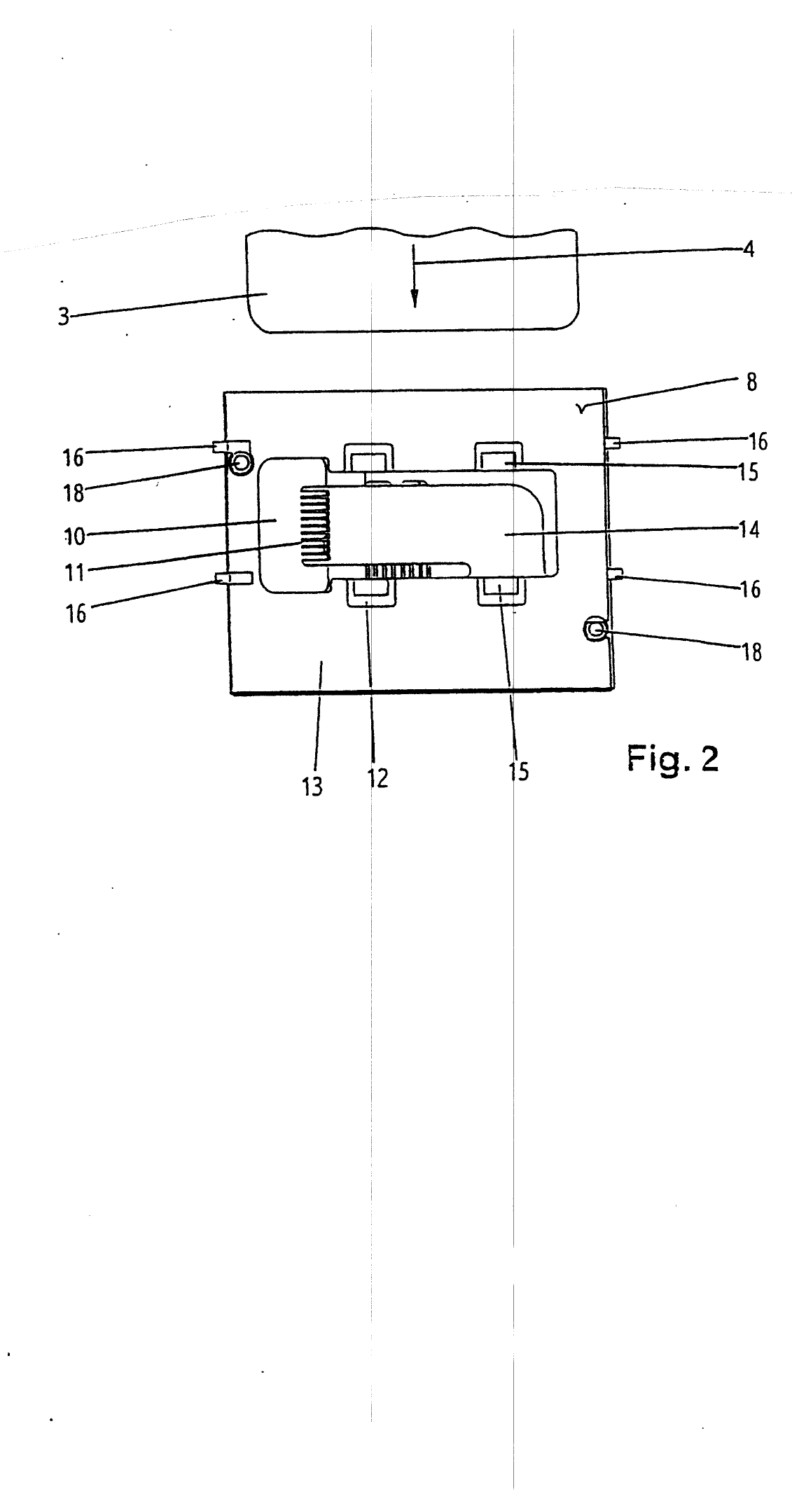

The chip card reader 1, shown in FIGS. 1 and 2, comprises a contacting unit 2 with eight electrical contact springs (not shown) in order to contact electric contact fields of a chip card 3 that has been inserted into the contacting unit 2. The chip card 3 has a microchip (not shown) for storing data, whose contacts are provided as electric contact fields (not shown) on the card surface. The user inserts the chip card 3 in the insertion direction 4 via a card insertion opening 5 into the contacting unit 2 up to the data exchange position, and removes it again from the contacting unit 2 after data exchange (so-called push/pull card reader).

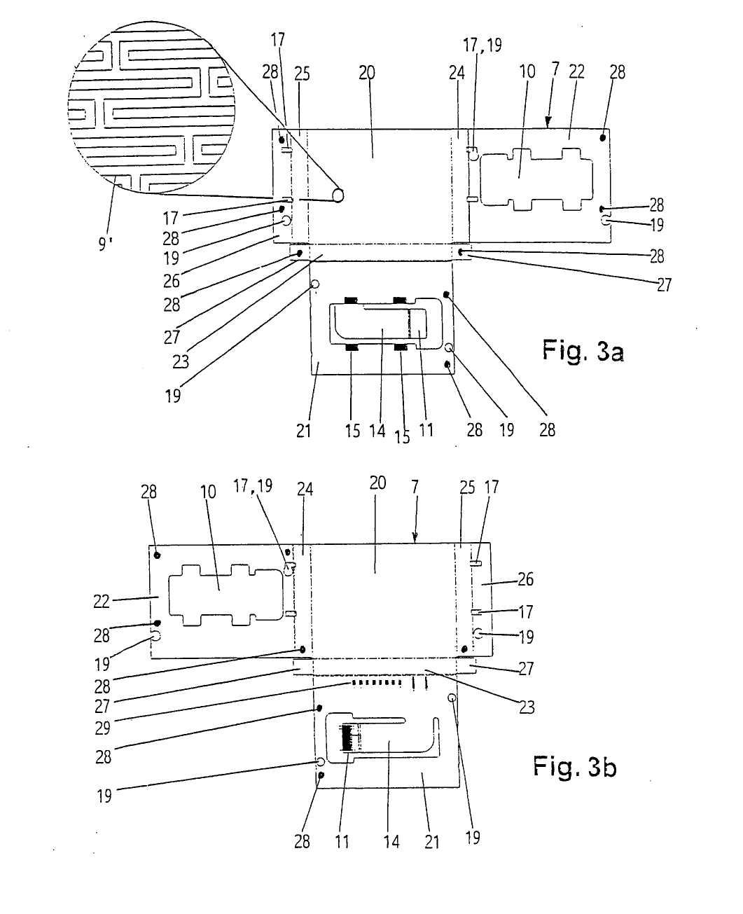

In order to protect the contacting unit 2 against manipulation, the contacting unit 2 is disposed in a pocket (drilling protection pocket) 6 which is open at the card insertion opening 5 and is folded from one single conductor path foil blank 7, as is described below with reference to FIG. 3. The circumferential surface of the pocket 6 has a fine-meshed, meandering conductor path structure with two continuous conductor paths 9, except for the lower pocket side forming the bottom 8 of the card reader 1. The bottom 8 has a recess 10, within which the connecting contacts 11 of the card reader 1 are provided. In the illustrated embodiment, the lower pocket side has two layers, an inner and an outer bottom layer 12, 13, wherein only the outer bottom layer 13 has the recess 10. The inner bottom layer 12 within the recess 10 has a conductor path strip 14 whose free flexible end comprises a plug with connecting contacts 11. The inner bottom layer 12 moreover has four exposed contact surfaces (soldering pads) 15 within the recess 10 at both sides of the conductor path strip 14, which provide electrical contact between a customer's printed circuit board (not shown) and the card reader 1 disposed thereon, e.g. using an electrically conducting rubber. The card reader 1 is mounted to the customer's printed circuit board by means of four contact legs (soldering pads) 16 of the contacting unit 2, which project through corresponding holes 17 (FIG. 3) of the pocket 6 and are soldered to the customer's printed circuit board using SMD technology. The contacting unit 2 has two pins 18 at two diagonally opposite locations on the bottom side, which penetrate through corresponding holes 19 (FIG. 3) of the pocket 6, thereby positioning the pocket 6 on the contacting unit 2.

FIGS. 3a and 3b show the conductor path foil blank 7 from which the pocket 6 is folded around the contacting unit 2. The blank 7 has a cover section 20 that forms the upper side of the pocket, a first bottom section 21 that forms the inner bottom layer 12, and a second bottom section 22 that forms the outer bottom layer 13, wherein each bottom section 21, 22 is connected to the cover section 20 via side wall sections 23, 24. On its side opposite to the second bottom section 22, the cover section 20 is connected to part section 26 of the cover via a side wall section 25. Tab sections 27 are provided on both sides of the side wall 23. Since the interconnected sections are flexible, they can be bent at the folding lines indicated with dash-dotted lines. The holes 17 for the contact legs 16 of the contacting unit 2 are provided in the sections 22, 26, and the holes 19 for the pins 18 of the contacting unit 2 are provided in the sections 21, 22, 26. The conductor path foil blank 7 has an area-wide conductor path structure on its upper and lower sides, with several open conductor paths 9′ which have a meandering shape with minimum separation, except for the two bottom sections 21, 22. The open conductor paths 9′ terminate in the exposed contact surfaces 15 of the first bottom section 21 and in the exposed contact surfaces of the sections 21, 22, 24, 25, 26, 26, designated with 28. For connecting to the eight contact springs of the contacting unit 2 and to an end switch (not shown), the first bottom section 21 has ten connections (soldering pads) 29 which are connected to the connecting contacts 11 via the conductor paths of the conductor path strip 14. The two bottom sections 21, 22 have a larger thickness than the flexible sections 23 through 27 and may be designed as rigid printed circuit boards.

The erection of the conductor path foil blank 7 to form the pocket 6 is described below: The contacting unit 2 is disposed on the inner side of the first bottom section 21, shown in FIG. 3b, and soldered to its connections 29. The cover section 20, the tab sections 27, the part section 26 of the cover, and finally the second bottom section 22 are subsequently bent towards the contacting unit 2, whereby two contact surfaces 28 of two mutually overlapping sections 21/22, 22/26, 24/27 and 25/27 come into abutment. The abutting contact surfaces 28 are electrically connected via a previously disposed electrically conducting adhesive in order to form one continuous conductor path 7 on each of the inner and outer sides, wherein each continuous conductor path 7 connects two of the contact surfaces 15.

The connecting contacts 11 of the card reader 1 are connected to a corresponding plug (e.g. Molex plug) of the customer's printed circuit board, and then mounted to the customer's printed circuit board using the contact legs 16, wherein at the same time, an electrical connection between the contact surfaces 15 and the corresponding counter contacts of the customer's printed circuit board is established e.g. using an intermediate electrically conducting rubber. The counter contacts are connected to a control unit (not shown) of the customer's printed circuit board. Both the connecting contacts 11 of the card reader 1 and the plug of the customer's printed circuit board are completely accommodated in the recess 10 of the card reader 1, which is covered by the customer's printed circuit board, and are therefore not accessible from the outside. The outer bottom layer 13 or the second bottom section 22 ensure that the thickness of the bottom 8 is sufficiently large to receive the entire connecting contacts 11 and plugs within the recess 10.

When the pocket 6 is removed or destroyed e.g. by drilling, one or both continuous conductor paths 9, through which a current flows during operation, is/are cut through. The control unit of the customer's printed circuit board will detect this and subsequently prevent any reading process or render the contacting unit 2 inoperative. The same applies when the electric circuit between the contacting surfaces 15 is interrupted by removing the contacting unit 2 from the customer's printed circuit board. It is therefore not possible to manipulate the contacting unit 2 without being detected, thereby providing a “tamper-proof” card reader.

What is claimed is:

1. A card reader having a card insertion opening, said card reader comprising:
a contacting unit, disposed in a pockets open at the card insertion opening, having a fine-meshed conductor path structure with at least one continuous conductor path, said conductor path structure being formed from at least one conductor path foil by mutually overlapping sections, said overlapping sections comprising conductor path ends electrically interconnected to form the container conductor path; and
a pocket side forming a bottom of the card reader with a recess for contacting the contacting unit.

2. The card reader according to claim 1, wherein the conductor path ends of the mutually overlapping sections include exposed contact surfaces electrically connected to each other.

3. The card reader according to claim 1, wherein the bottom of the card reader includes exposed contact surfaces terminating in the continuous conductor path.

4. The card reader according to claim 1, wherein the contacting unit includes connecting contacts disposed within the recess.

5. The card reader according to claim 1, wherein the bottom is formed by two layers, an inner and an outer bottom layer, the recess is disposed in the outer bottom layer, and connecting contacts of the contacting unit are disposed on the inner bottom layer.

6. The card reader according to claim 1, wherein the bottom is thicker than pocket sides.

7. The card reader according to claim 1, wherein the contacting unit includes contacting legs projecting to an outside through pocket holes

8. The card reader according to claim 1, wherein the contacting includes pins engaging corresponding holes of the pocket.

9. A one-piece conductor foil path blank for a pocket of the card reader according to claim 1, comprising a cover section forming a upper side of the pocket, and at least one bottom section forming a bottom of the pocket and further comprising a recess, and side wall sections, wherein at least the cover section and the side wall sections have a fine-meshed conductor path structure with several open conductor paths which terminate in exposed contact surfaces of the sections which abut each other in pairs when the pocket is erected, and in exposed contact surfaces of the bottom section.

10. The blank according to claim 9, wherein the bottom section is thicker than the other sections.

11. The blank according to claim 9, wherein two bottom sections form a two-layered bottom of the pocket and wherein one bottom section comprises the recess and the other bottom section comprises connecting contacts for the contacting unit.
